(19) United States
(12) Patent Application Publication
(10) Pub. No.: US 2009/0295921 A1
(43) Pub. Date: Dec. 3, 2009

(54) VEHICLE-MOUNTED PHOTOGRAPHING DEVICE AND METHOD OF MEASURING PHOTOGRAPHABLE RANGE OF VEHICLE-MOUNTED CAMERA

(75) Inventor: Ryujiro Fujita, Saitama (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION, Tokyo (JP)

(21) Appl. No.: 12/089,875

(22) PCT Filed: Sep. 29, 2006
(86) PCT No.: PCT/JP2006/320040

§ 371 Date: Aug. 1, 2008

(30) Foreign Application Priority Data
Oct. 12, 2005 (JP) 2005-297536

(51) Int. Cl. H04N 7/18

(52) U.S. Cl. 348/148; 348/E07.085

(57) ABSTRACT

A vehicle-mounted pickup device measures an image pickup movable range of a camera mounted inside a vehicle based on a video signal obtained by picking up images with the camera, while changing (rotating) the image pickup direction of the camera in the yaw direction. The vehicle-mounted pickup device can increase a degree of freedom in selecting the instillation position of the camera inside the vehicle.

### TECHNICAL FIELD

The present invention relates to an image pickup device (photographing device or video-taping device) that is mounted on a movable body, in particular a vehicle, and to a method of measuring an image pickup movable range (photographable range) of a vehicle-mounted camera.

### BACKGROUND ART

Japanese Patent Application Laid-open (Kokai) No. 08-265611 discloses a vehicle-mounted monitoring device designed to perform safety verification behind a vehicle and monitoring the inside of the vehicle.

Such vehicle-mounted monitoring device includes a camera that is provided at the upper area of a rear glass of the vehicle so as to be able to rotate and direct its image pickup from behind the vehicle to the inside of the vehicle. For example, when all the space behind the vehicle is to be monitored by using a zoom function of the camera, the camera is gradually rotated within a range (angular range) in which the space behind the vehicle is picked up. When the inside of the vehicle should entirely be monitored, the orientation of the camera is gradually changed (rotated) within a range (angular range) in which the inside of the vehicle is picked up.

The range (angular range) in which the space behind the vehicle is picked up and the range (angular range) in which the inside of the vehicle is picked up vary depending on the mounting position of the camera.

Therefore, in order to perform the rotation of the camera automatically by a device, the camera has to be mounted in a predetermined position inside the vehicle, and therefore restrictions are imposed on installation thereof.

### DISCLOSURE OF THE INVENTION

One object of the present invention is to provide a vehicle-mounted image pickup device that can increase the degree of freedom in selecting the installation position of a camera.

Another object of the present invention is to provide a method of measuring an image pickup movable range for a vehicle-mounted camera that can increase the degree of freedom in selecting the installation position of the camera.

According to the first aspect of the present invention, there is provided a vehicle-mounted image pickup device that picks up a scene inside a vehicle cabin or outside the vehicle. The image pickup device includes a camera, and a camera platform for fixedly mounting the camera inside the vehicle and rotating (turning) the camera according to a rotation signal generated in order to change an image pickup (photographing) direction of the camera. The image pickup device also includes image pickup movable range measurement means for measuring an image pickup movable range of the camera based on a video signal obtained by picking up images with the camera, while supplying the rotation signal to rotate (turn) the pickup direction of the camera to a yaw direction, and storage means for storing information indicating the image pickup movable range.

The image pickup movable range of the camera is measured based on a video signal obtained by picking up images with the camera, while rotating the image pickup direction of the camera installed inside the vehicle in the yaw direction in response to switching on a power source. As a result, the image pickup movable range of the camera is automatically measured based on the camera installation position. Therefore, the degree of freedom in selecting the installation position of camera inside the vehicle is increased and a load on a software application using the image picked up with the camera is reduced.

According to the second aspect of the present invention, there is provided an image pickup movable range measuring method for a vehicle-mounted camera to determine an image pickup movable range of a camera installed inside a vehicle cabin. The method includes an in-vehicle image pickup movable range measurement step of detecting an A pillar of the vehicle from an image represented by a video signal obtained by picking up images with the camera, while gradually rotating the pickup direction of the camera from one direction inside the vehicle, to a yaw direction, and measuring the in-vehicle image pickup movable range based on the image pickup direction of the camera when the A pillar is detected. The method also includes an outside-vehicle image pickup movable range measurement step of detecting the A pillar from an image represented by the video signal, while gradually rotating the image pickup direction of the camera from one direction outside the vehicle, to a yaw direction, and measuring the outside-vehicle image pickup movable range based on the image pickup direction of the camera when the A pillar is detected.

The image pickup movable range of the camera at the time the images are picked up inside the vehicle cabin and image pickup movable range of the camera at the time the images are picked up outside the vehicle are measured separately from each other based on the video signal. As a result, when a software application is designed to pick up the images inside and outside the vehicle while rotating (turning) the camera, it can know in advance the in-vehicle image pickup movable range and the outside-vehicle image pickup movable range for the camera. Therefore, the rotation operation during switching of the pickup direction of the camera from inside the vehicle (outside the vehicle) to the outside the vehicle (inside the vehicle) can be implemented at a high speed.

### BRIEF DESCRIPTION OF THE DRAWINGS

FIG. 1 illustrates some parts of a vehicle-mounted information-processing apparatus including the vehicle-mounted image pickup device according to an embodiment of the present invention;

FIG. 2 shows an image pickup initial setting subroutine;

FIG. 3 shows an in-vehicle feature finding subroutine;

FIG. 4 shows part of a RAM memory map;

FIG. 5 shows a camera attachment position detecting subroutine;

FIGS. 6A, 6B, and 6C serve to explain the operation performed when the camera installation position detecting subroutine is executed;

FIG. 7 shows an example of an installation position of a video camera inside a vehicle and also shows an example of an in-vehicle image pickup movable range and an outside-vehicle image pickup movable range;

FIG. 8 shows an in-vehicle image pickup movable range detection subroutine;

FIG. 9 shows an in-vehicle image pickup movable range detection subroutine;

FIG. 10 shows an outside-vehicle image pickup movable range detection subroutine;

FIG. 11 shows an outside-vehicle image pickup movable range detection subroutine;

FIG. 12 shows a vanishing point detection subroutine;

FIG. 13 shows another example of an in-vehicle image pickup movable range detection subroutine; and

FIG. 14 shows another example of an outside-vehicle image pickup movable range detection subroutine.

### MODE FOR CARRYING OUT THE INVENTION

Embodiments of the present invention will be explained below with reference to the appended drawings.

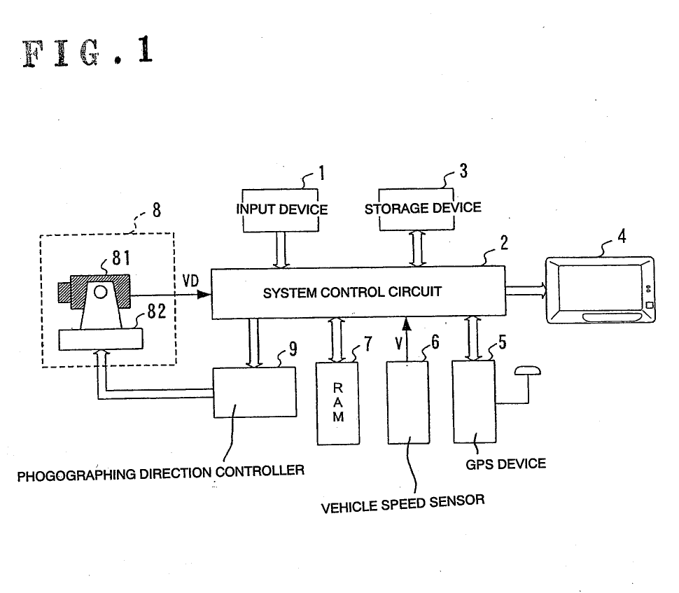

Referring to FIG. 1, an input device 1 receives a command corresponding to each operation from a user and supplies a command signal corresponding to the operation to a system control circuit 2. Programs for implementing various functions of a vehicle-mounted information-processing apparatus and various information data are stored in advance in a storage device 3. In response to a read command supplied from the system control circuit 2, the storage device 3 reads the program or information data designated by the read command and supplies them to the system control circuit 2. A display device 4 displays an image corresponding to a video signal supplied from the system control circuit 2. A GPS (Global Positioning System) device 5 detects the present position of the vehicle based on an electromagnetic wave from a GPS satellite and supplies the vehicle position information that indicates the present position to the system control circuit 2. A vehicle speed sensor 6 detects the traveling speed of the vehicle that carries the vehicle-mounted information-processing apparatus and supplies a vehicle speed signal V indicating the vehicle speed to the system control circuit 2. A RAM (random access memory) 7 performs writing and reading of each intermediately generated information, which is described hereinbelow, in response to write and read commands from the system control circuit 2.

A video camera 8 has a camera body 81 containing an image pickup element and a camera platform 82 that can rotate the camera body 81 independently in the yaw direction, roll direction, and pitch direction. The camera body 81 has the image pickup element and supplies a video signal VD obtained by picking up images with the image pickup element to the system control circuit 2. The camera platform 82 rotates and changes the image pickup (photographing) direction of the camera body 81 in the yaw direction in response to a yaw direction rotation signal supplied from an image pickup direction control circuit 9. The camera platform 82 rotates and changes the image pickup direction of the camera body 81 in the pitch direction in response to a pitch direction rotation signal supplied from the image pickup direction control circuit 9. The camera platform 82 rotates and changes the image pickup direction of the camera body 81 in the roll direction in response to a roll direction rotation signal supplied from the image pickup direction control circuit 9.

The video camera 8 is installed in a location in which it can pick up images both inside the vehicle cabin and outside the vehicle, while the camera body 71 is completes one rotation in the yaw direction. For example, the video camera is attached onto a dashboard, onto or near a room mirror, onto or near a front glass (windshield), or located in the rear section inside the vehicle, for example, on or near the rear window.

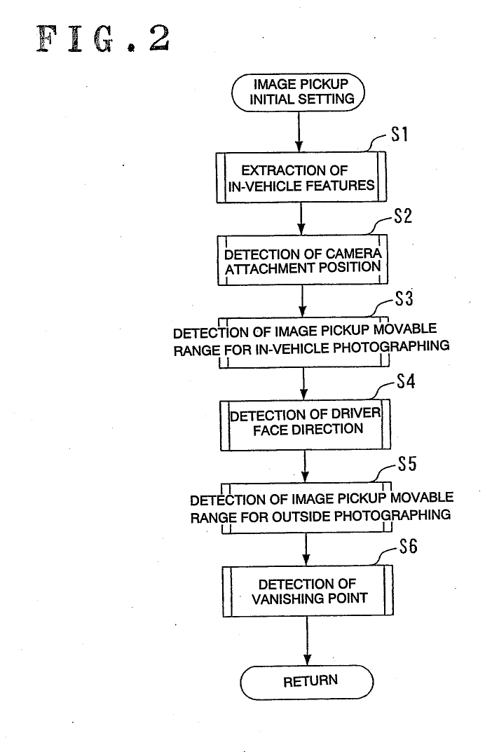

If an electric power is supplied to the vehicle-mounted information-processing apparatus in response to the vehicle ignition key operation performed by the user, the system control circuit 2 executes the control according an image pickup initial setting subroutine shown in FIG. 2.

Referring to FIG. 2, the system control circuit 2 first executes the control according to an in-vehicle feature extraction subroutine (step S1).

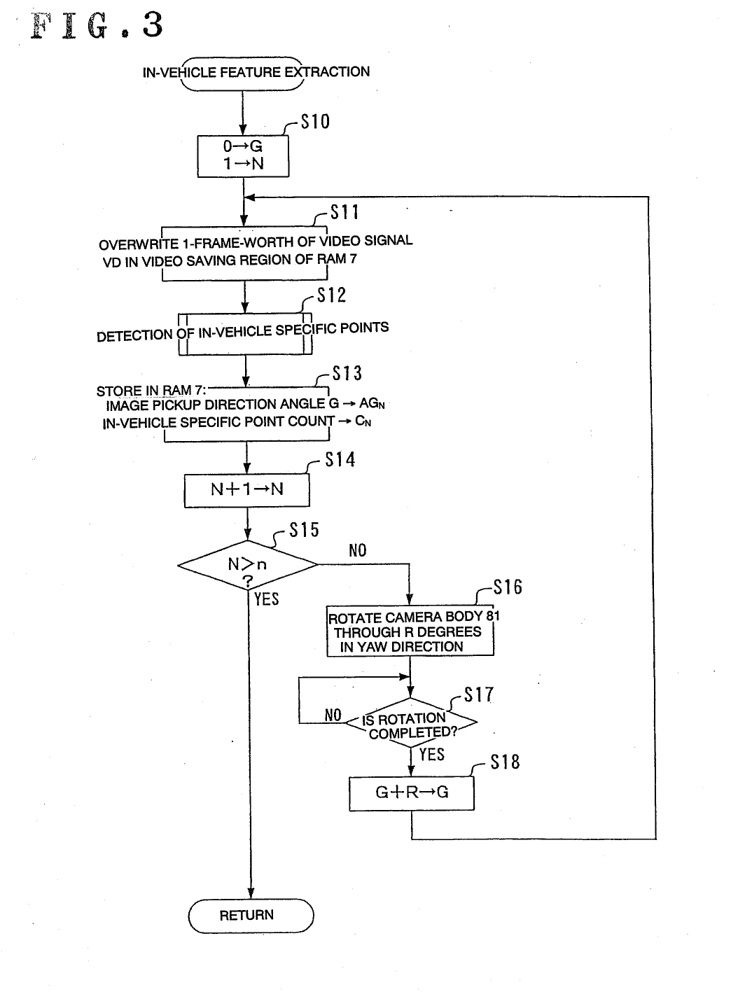

FIG. 3 shows the in-vehicle feature extraction subroutine.

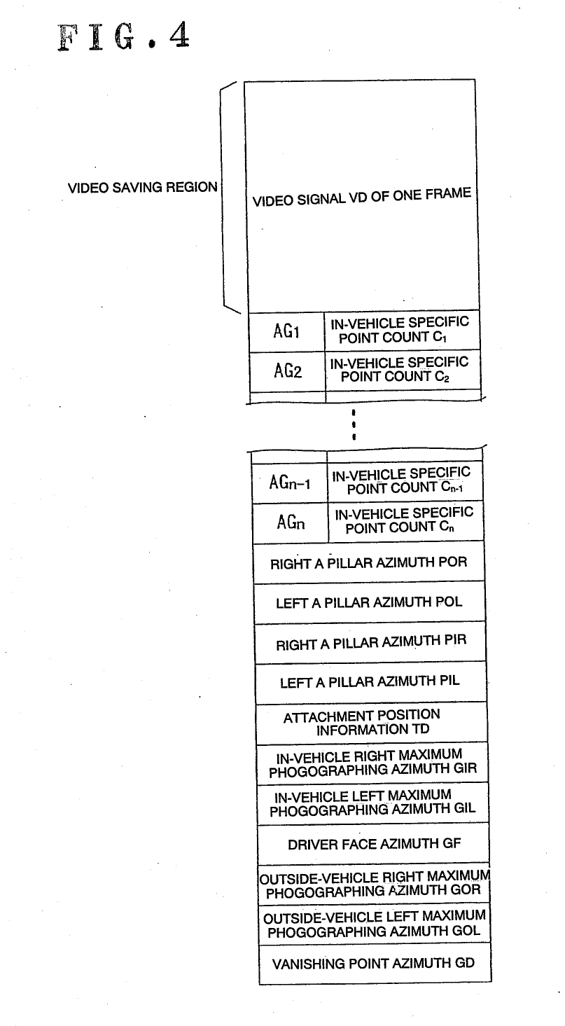

Referring to FIG. 3, first, the system control circuit 2 stores “0” as an initial value of a pickup direction angle G and “1” as an initial value of an image pickup direction variation count N in a storage register (not shown in the figure) (step S10). Then, the system control circuit 2 fetches a video signal VD representing a video image, which is captured by the video camera 8. The video image shows the inside of the vehicle cabin (simply referred to hereinbelow as “inside the vehicle”) by one frame. The system control circuit 2 overwrites the video signal for storage in a video saving region of the RAM 7 shown in FIG. 4 (step S11).

Then, the system control circuit 2 performs the in-vehicle specific point detection processing on the video signal VD of one frame that has been stored in the video saving region of the RAM 7 (step S12). Thus, an edge processing and a shape analysis processing are applied on the video signal VD in order to detect specific portions inside the vehicle, for example, part of a driver seat, part of a passenger seat, part of a rear seat, part of a headrest and/or part of a rear window, among a variety of articles that have been installed in advance inside the vehicle, from the image derived from the video signal VD. The total number of the in-vehicle specific portions that are thus detected is counted. Following the execution of the step S12, the system control circuit 2 associates the in-vehicle specific point count C_{N} (N is the measurement count that has been stored in the storage register) indicating the total number of in-vehicle specific portions with an image pickup direction angle AG_{N} indicating an image pickup angle G that has been stored in the storage register, as shown in FIG. 4, and stores them in the RAM 7 (step S13).

Then, the system control circuit 2 adds 1 to the image pickup direction variation count N that has been stored in the storage register, takes the result as a new image pickup direction variation count N, and overwrites and stores it in the storage register (step S14). Then, the system control circuit 2 determines whether the image pickup direction variation count N that has been stored in the storage register is larger than a maximum number n (step S15). If the image pickup direction variation count N is determined not to be larger than the maximum number n in the step S15, the system control circuit 2 supplies a command to rotate the camera body 81 through a predetermined angle R (for example, 30 degrees) in the yaw direction to the image pickup direction control circuit 9 (step S16). As a result, the camera platform 82 of the video camera 8 rotates the present image pickup direction of the camera body 81 through the predetermined angle R in the yaw direction. In this process, the operation of determining whether the rotation through the predetermined angle R in the camera body 81 has been completed is repeatedly executed by the system control circuit 2 till it determines that the rotation has been completed (step S17). If the rotation of the camera body 81 is determined to have been completed in the step S17, the system control circuit 2 adds the predetermined angle R to the image pickup direction angle G that has been stored in the storage register, takes the result as a new image pickup direction angle G and overwrites it and stores in the storage register (step S18). Upon completion of the step S18, the system control circuit 2 returns to the execution of the step S11 and repeatedly executes the above-described operations.

By repeating a series of operations of the steps S11 to S18, the in-vehicle specific point counts C1 to Cn indicating the total number of specific points inside the vehicle that are individually detected from an image when the images inside the vehicle are picked up at n different angles (first to n-th image pickup direction angles AG1 to AGn) are associated with the image pickup direction angles AG1 to AGn, as shown in FIG. 4, and stored in the RAM 7.

In this process, if the image pickup direction variation count N is determined in the step S15 to be larger than the maximum number n, the system control circuit 2 quits (exits) the in-vehicle feature extraction subroutine and returns to the step S2 shown in FIG. 2.

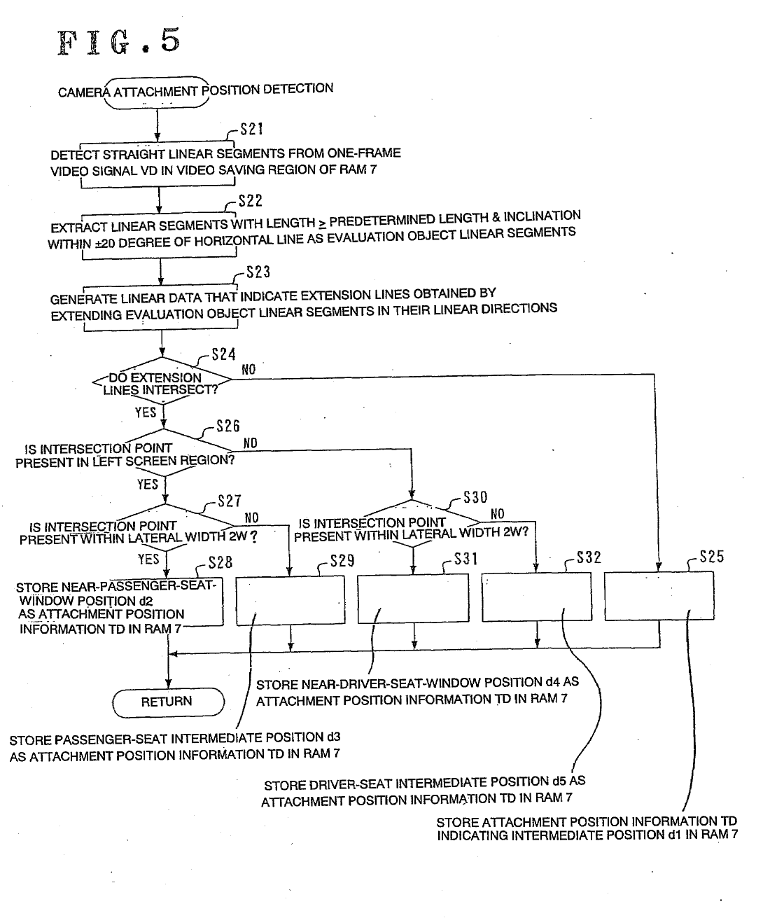

In the step S2, the system control circuit 2 executes the camera attachment position detecting subroutine shown in FIG. 5.

Referring to FIG. 5, first, the system control circuit 2 detects the boundary portion of the so-called display(ed) body at which the luminance level changes abruptly from among the images represented by the video signal of one frame that has been stored in the video saving region of the RAM 7 shown in FIG. 4, and then detects all the straight segments from this boundary portion (step S21). Then, from among the straight segments, the system control circuit 2 extracts those linear segments which have a length equal to or larger than a predetermined length and an inclination of ±20 degrees or less to a horizontal direction and takes them as evaluation object linear segments (step S22).

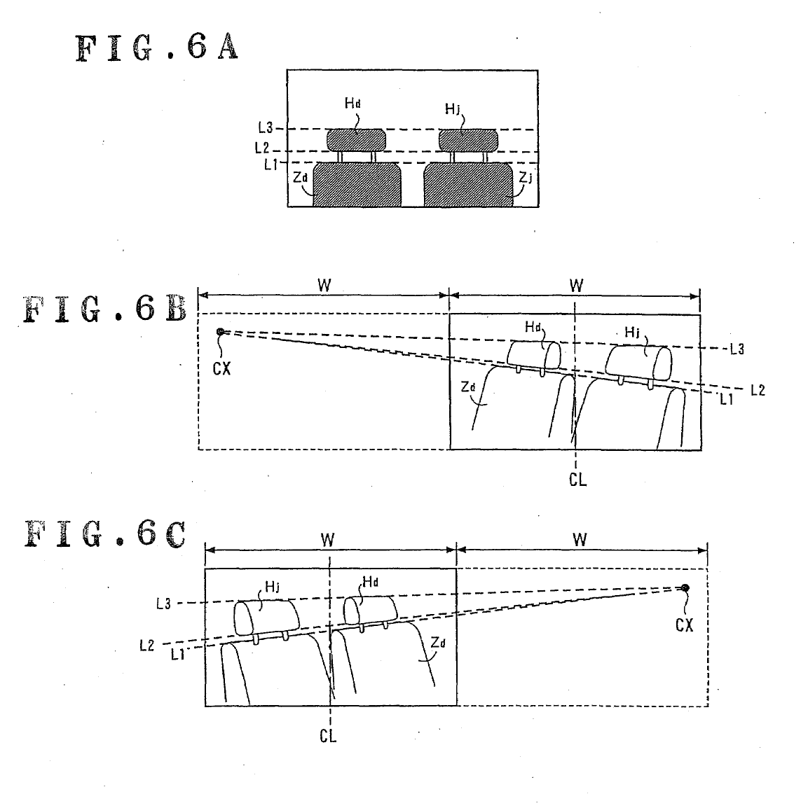

Then, the system control circuit 2 generates linear data indicating extension lines obtained by extending each evaluation object linear segment in the linear direction thereof (step S23). For example, when an image represented by the video signal of one frame is an image shown in FIG. 6A, three linear data are generated that correspond to an extension line L1 (shown by the broken line) corresponding to an upper edge of a driver seat backrest Zd and to extension lines L2 and L3 (shown by the broken lines) that respectively correspond to the lower edge and upper edge of the driver seat headrest Hd.

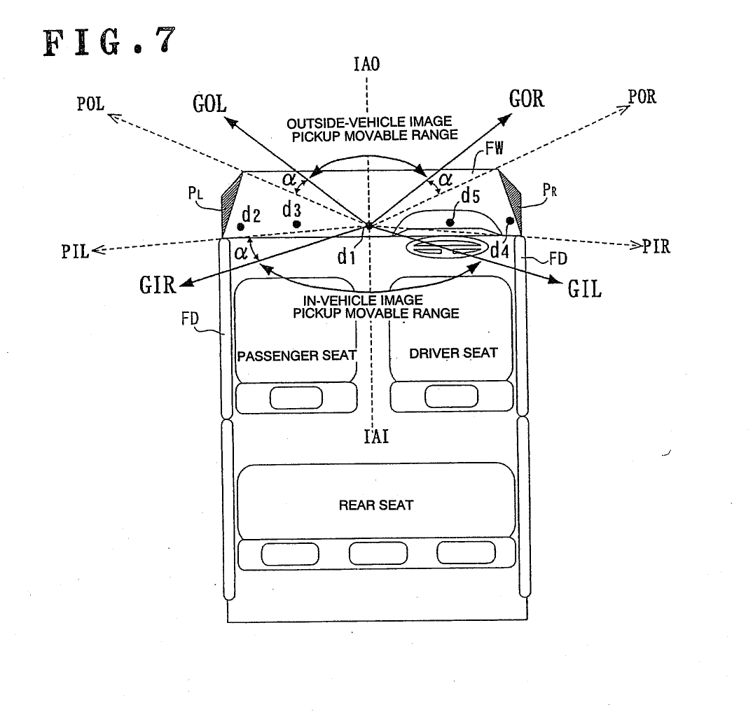

Then, the system control circuit 2 determines whether the extension lines intersect based on the linear data (step S24). If the extension lines are determined in the step S24 not to intersect, the system control circuit 2 stores the attachment position information TD indicating that an attachment position of the video camera 8 is a central position dl inside the vehicle, as shown in FIG. 7, in the RAM 7 as shown in FIG. 4 (step S25). Thus, if the image represented by the video signal of one frame is that shown in FIG. 6A, the extension lines L1 to L3 shown by the broken lines do not intersect with each other and, therefore, the attachment position of the video camera 8 is determined to be the central position dl inside the vehicle as shown in FIG. 7.

On the other hand, if the extension lines are determined in the step S24 to intersect with each other, the system control circuit 2 then determines whether the intersection point is present on the left side of one screen in the case the screen is divided in two sections by a central vertical line (step S26). Thus, if the image represented by the video signal of one frame is an image shown in FIG. 6B or FIG. 6C, the extension lines L1 to L3 intersect in an intersection point CX. Therefore, the system control circuit 2 determines whether the intersection point CX is present on the left side, as shown in FIG. 6B, with respect to the central vertical line CL, or on the right side, as shown in FIG. 6C.

If the intersection point is determined in the step S26 to be present on the left side, the system control circuit 2 then determines whether the intersection point is present within a region with a width 2W that is twice as large as the width W of one screen (step S27). If the intersection point is determined in the step S27 to be present within the range with the width 2W, the system control circuit 2 stores the attachment position information TD that indicates that the attachment position of the video camera 8 is a position d2 on the passenger seat window side inside the vehicle, as shown in FIG. 7, in the RAM 7 as shown in FIG. 4 (step S28). Thus, where the intersection point CX of the extension lines L1 to L3 is positioned on the left of the central vertical line CL and the position of this intersection point CX is within the region with a lateral width 2W that is twice as large as the lateral width W of one screen, as shown in FIG. 6B, it is determined that the attachment position of the video camera 8 is the position d2 on the passenger seat window side inside the vehicle, as shown in FIG. 7.

On the other hand, if the intersection point is determined in the step S27 not to be present within the region with a lateral width of 2W, the system control circuit 2 stores the attachment position information TD that indicates that the attachment position of the video camera 8 is an intermediate position d3 on the passenger seat side that is an intermediate position between the central position dl and the position d2 near the passenger seat window inside the vehicle, as shown in FIG. 7, in the RAM 7 as shown in FIG. 4 (step S29). Thus, if the intersection point CX of the extension lines L1 to L3 is positioned on the left side of the central vertical line CL and the position of this intersection point CX is outside the region with a lateral width 2W that is twice as large as the lateral width W of one screen, as shown in FIG. 6B, it is determined that the attachment position of the video camera 8 is the intermediate position d3 on the passenger seat side inside the vehicle, as shown in FIG. 7.

If the intersection point is determined in the step S26 not to be present in the left half of the screen, the system control circuit 2 then determines whether the intersection point is present within a region with a lateral width 2W that is twice as large as the lateral width W of one screen (step S30). If the intersection point is determined in the step S30 to be present within the range with a lateral width 2W, the system control circuit 2 stores the attachment position information TD that indicates that the attachment position of the video camera 8 is a position d4 near the driver seat window inside the vehicle, as shown in FIG. 7, in the RAM 7 as shown in FIG. 4 (step S31). Thus, if the intersection point CX of the extension lines L1 to L3 is positioned on the right side of the central vertical line CL and the position of this intersection point CX is within the region with a lateral width 2W that is twice as large as the lateral width W of one screen, as shown in FIG. 6C, it is determined that the attachment position of the video camera 8 is a position d4 near the driver seat window inside the vehicle, as shown in FIG. 7.

On the other hand, if the intersection point is determined in the step S30 not to be present within the region with a lateral width of 2W, the system control circuit 2 stores the attachment position information TD that indicates that the attachment position of the video camera 8 is an intermediate position d5 on the driver seat side that is an intermediate position between the central position dl and the position d4 near the driver seat window in the vehicle, as shown in FIG. 7, in the RAM 7 as shown in FIG. 4 (step S29). Thus, if the intersection point CX of the extension lines L1 to L3 is positioned on the right side of the central vertical line CL and the position of this intersection point CX is outside the region with a lateral width 2W that is twice as large as the lateral width W of one screen, as shown in FIG. 6C, it is determined that the attachment position of the video camera 8 is the intermediate position d5 on the driver seat side inside the vehicle, as shown in FIG. 7.

After the processing of the step S25, S28, S29, S31 or S32 is executed, the system control circuit 2 quits the camera attachment position detection subroutine and returns to the step S3 in FIG. 2.

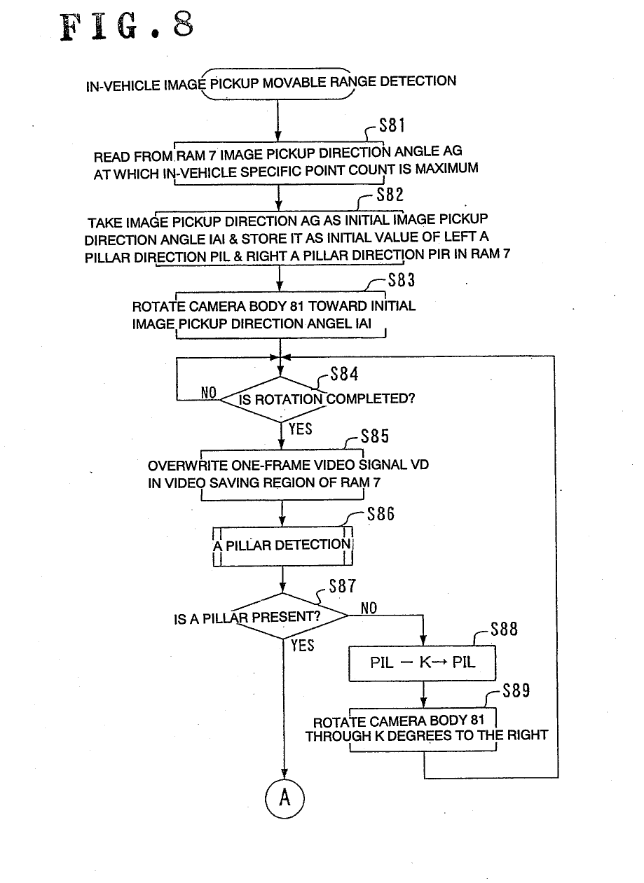

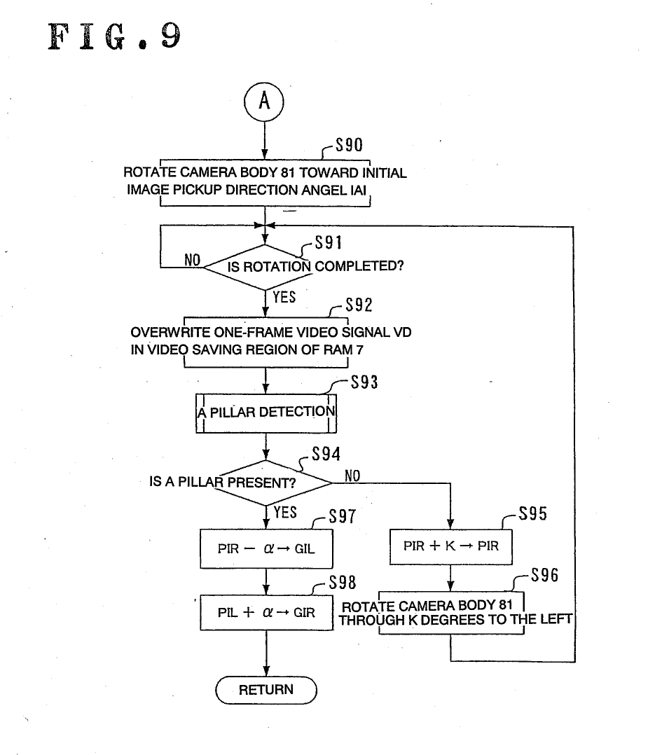

In the step S3, the system control circuit 2 executes an in-vehicle image pickup movable range detection subroutine as shown in FIG. 8 and FIG. 9.

Referring to FIG. 8, first, the system control circuit 2 reads an image pickup direction angle AG corresponding to the in-vehicle specific point count C, which is the largest from among the in-vehicle specific point counts C₁ to Cₙ, from among the image pickup direction angles AG₁ to AGₙ that have been stored in the RAM 7 as shown in FIG. 4 (step S81). Then, the system control circuit 2 takes the image pickup direction angle AG as an initial image pickup direction angle IAI and stores it as the initial value of a left A pillar azimuth PIL and right A pillar azimuth PIR in the RAM 7 as shown in FIG. 4 (step S82).

Then the system control circuit 2 supplies a command to rotate the camera body 81 in the yaw direction toward the initial image pickup direction angle IAI to the image pickup direction control circuit 9 (step S83). As a result, the platform 82 of the video camera 8 rotates the image pickup direction of the camera body 81 in the direction indicated by the initial image pickup direction angle IAI. In this process, the operation of determining whether the rotation of the camera body 81 has been completed is repeatedly executed by the system control circuit 2 till it determines that the rotation has been completed (step S84). If the rotation of the camera body 81 is determined to be completed in the step S84, the system control circuit 2 fetches one frame of the video signal VD representing a video image within the vehicle that is picked up by the video camera 8 and overwrites and stores it in the video saving region of the RAM 7 as shown in FIG. 4 (step S85).

Then, the system control circuit 2 performs the A pillar detection processing on the one-frame video signal VD that has been stored in the video saving region of the RAM 7 (step S86). Thus, the video signal VD is subjected to an edge processing and shape analysis processing in order to detect the A pillar P_{R} or P_{L} provided at the boundary between a front window FW and front door FD of the vehicle, as shown in FIG. 7, from among the images derived from the video signal VD. This A pillar is one of the pillars supporting the cabin roof of the vehicle.

Then, the system control circuit 2 determines whether the A pillar has been detected from among the images of the one-frame video signal VD by the A pillar detection processing (step S87). If the A pillar is determined to have been undetected in the step S87, the system control circuit 2 subtracts a predetermined angle K (for example, 10 degrees) from the angle indicated by a left A pillar azimuth PIL, as shown in FIG. 4, that has been stored in the RAM 7 and overwrites and stores the resultant angle as a new left A pillar azimuth PIL in the RAM 7 (step S88).

Then, the system control circuit 2 supplies a command to rotate the camera body 81 to the right through the predetermined angle K to the image pickup direction control circuit 9 (step S89). As a result, the platform 82 of the video camera 8 rotates the image pickup direction of the camera body 81 from the present image pickup direction to the right through the predetermined angle K. After the processing of the step S89 is executed, the system control circuit 2 returns to the step S84 and repeatedly executes the operation of the steps S84 to S89. Thus, the image pickup direction is repeatedly rotated to the right by the predetermined angle K at a time till the A pillar is detected among the images picked up by the video camera 8, and an angle indicating the final image pickup direction is stored as a left A pillar azimuth PIL indicating the direction of the A pillar PL on the passenger seat side, as shown in FIG. 7, in the RAM 7.

If the A pillar is determined in the step S87 to have been detected, the system control circuit 2 issues a command to rotate the camera body 81 in the yaw direction toward the initial image pickup direction angle IAI, in the same manner as in the step S83, to the image pickup direction control circuit 9 (step S90). As a result, the platform 82 of the video camera 8 rotates the image pickup direction of the camera body 81 in the direction indicated by the initial image pickup direction angle IAI. In this process, the operation of determining whether the rotation of the camera body 81 has been completed is repeatedly executed by the system control circuit 2 till it determines that the rotation is completed (step S91).

If the rotation of the camera body 81 is determined in the step S91 to have been completed, the system control circuit 2 fetches one frame of the video signal VD representing the image within the vehicle picked up by the video camera 8 and overwrites and stores it in the video saving region of the RAM 7, as shown in FIG. 4 (step S92).

Then, similar to the step S86, the system control circuit 2 performs the A pillar detection processing on the one-frame video signal VD that has been stored in the video saving region of the RAM 7 (step S93).

Then, the system control circuit 2 determines whether the A pillar has been detected from among the images of the one-frame video signal VD by the A pillar detection processing (step S94). If the A pillar is determined to have been undetected in the step S94, the system control circuit 2 adds a predetermined angle K (for example, 10 degrees) to the angle of the right A pillar azimuth PIR shown in FIG. 4, that has been stored in the RAM 7, and overwrites and stores the resultant angle as a new right A pillar azimuth PIL in the RAM 7 (step S95).

Then, the system control circuit 2 supplies a command to rotate the camera body 81 to the left through the predetermined angle K to the image pickup direction control circuit 9 (step S96). As a result, the camera platform 82 of the video camera 8 rotates the image pickup direction of the camera body 81 from the present image pickup direction to the left through the predetermined angle K. After the processing of the step S96 is executed, the system control circuit 2 returns to the step S91 and repeatedly executes the operation of the steps S91 to S96. Thus, the image pickup direction is repeatedly rotated to the left by the predetermined angle K at a time till the A pillar is detected among the images picked up by the video camera 8, and an angle indicating the final image pickup direction is stored as a right A pillar azimuth PIR indicating the direction of the A pillar PR on the driver seat side, as shown in FIG. 7, in the RAM 7.

If the A pillar is determined in the step S94 to have been detected, the system control circuit 2 subtracts an angle a that is half the angle of view of the video camera 8 from the right A pillar azimuth PIR that has been stored in the RAM 7, as shown in FIG. 4, and stores the result as an in-vehicle left maximum image pickup azimuth GIL in the RAM 7 (step S97).

Then, the system control circuit 2 adds the angle α that is half the angle of view of the video camera 8 to the left A pillar azimuth PIL that has been stored in the RAM 7, as shown in FIG. 4, and stores the result as an in-vehicle right maximum image pickup azimuth GIR in the RAM 7 as shown in FIG. 4 (step S98). Thus, as shown in FIG. 7, with the A pillars P_{R} and P_{L} serving as boundaries, the front window (windshield) FW side becomes an outside-vehicle image pickup range and the front doors FD side becomes an in-vehicle image pickup range. The azimuths obtained by shifting toward the inside of the vehicle through the angle α that is half the angle of view of the video camera 8 from the image pickup directions (PIR, PIL) in which the A pillars (P_{R}, P_{L}) have been detected, are taken as the final in-vehicle right maximum image pickup azimuth GIR and in-vehicle left maximum image pickup azimuth GIL. Thus, the A pillars P_{R}, P_{L} are not included in the picked-up image when the images are picked up inside the vehicle.

After executing the processing of the steps S97 and S98, the system control circuit 2 quits the in-vehicle image pickup movable range detecting subroutine.

By executing the in-vehicle image pickup movable range detecting subroutine, it is possible to detect (or know or decide) the in-vehicle right maximum image pickup azimuth GIR and in-vehicle left maximum image pickup azimuth GIL that indicate the limit angles of the in-vehicle image pickup movable range at the time the video camera 8 picks up images inside the vehicle, as shown in FIG. 7.

In FIG. 7, the in-vehicle right maximum image pickup azimuth GIR and in-vehicle left maximum image pickup azimuth GIL of the in-vehicle image pickup movable range are shown, by way of an example, with respect to the case in which the video camera 8 is installed in the central position d1.

After executing the in-vehicle image pickup movable range detection subroutine, the system control circuit 2 returns to the step S4 shown in FIG. 2.

In the step S4, the system control circuit 2 executes a driver face direction detection subroutine to detect the direction in which the driver's face is present. In the driver face direction detection subroutine, the system control circuit 2 performs an edge processing and a shape analysis processing to detect the driver's face from the images derived from the video signals VD for each one-frame video signal VD obtained by picking up images with the camera body 81, while gradually rotating the image pickup direction of the camera body 81 in the yaw direction. If the driver's face is detected, the system control circuit 2 determines whether the image of the driver's face is positioned in the center of one frame image. The image pickup direction of the camera body 81 at the time the driver's face is determined to be positioned in the center is stored as a driver's face azimuth GF indicating the direction in which the driver's face is present in the RAM 7 as shown in FIG. 4. In this case, the one-frame video signal VD that represents the driver's face image is also stored in the RAM 7.

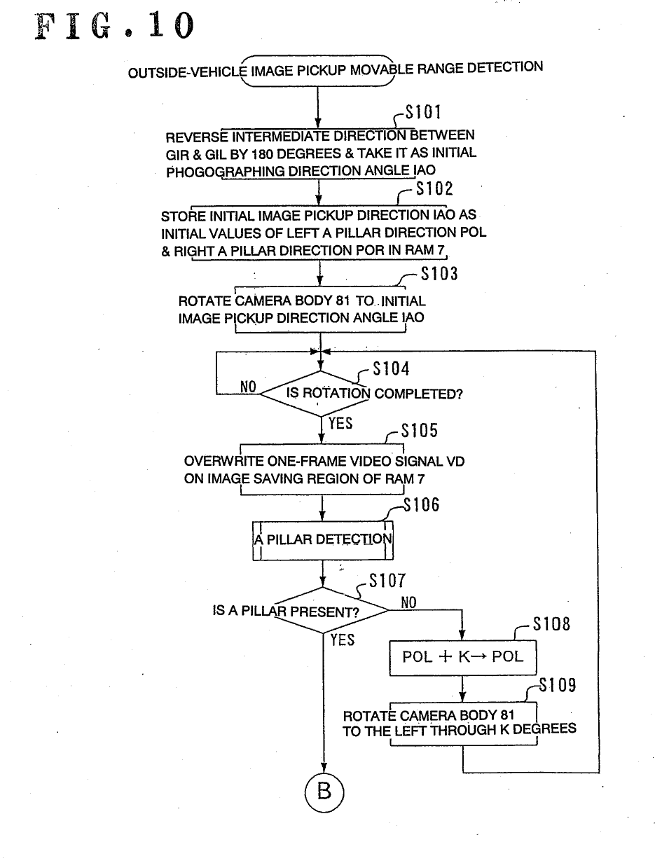

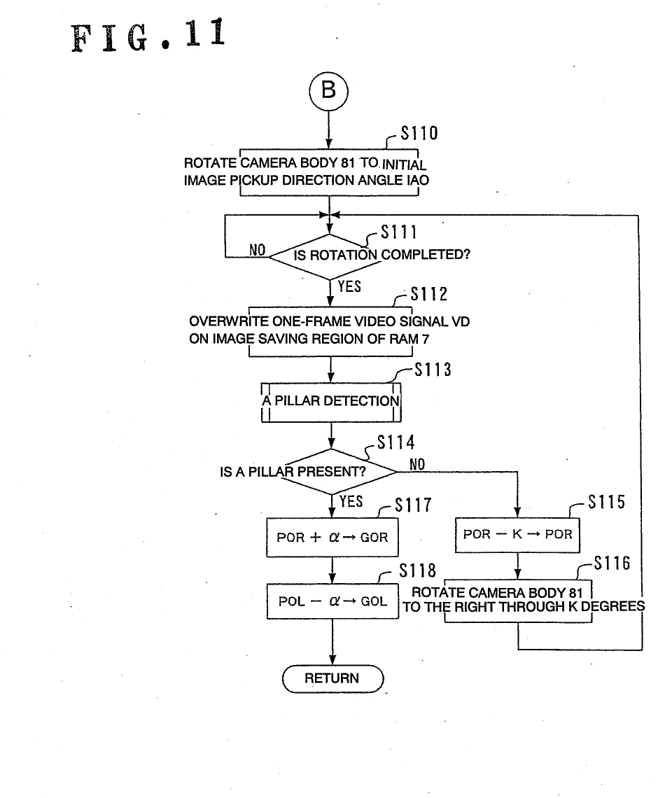

After executing the step S4, the system control circuit 2 executes an outside-vehicle image pickup movable range detection subroutine as shown in FIG. 10 and FIG. 11 (step S5).

Referring to FIG. 10, first, the system control circuit 2 reads the in-vehicle right maximum image pickup azimuth GIR and in-vehicle left maximum image pickup azimuth GIL that have been stored in the RAM 7 as shown in FIG. 4, and computes a direction obtained by 180° reversing the intermediate direction within the image pickup movable range represented by the angles GIR and GIL as an initial image pickup direction angle IAO (step S101). Then, the system control circuit 2 stores the initial image pickup direction angle IAO as the initial value of the left A pillar azimuth POL and right A pillar azimuth POR in the RAM 7 as shown in FIG. 4 (step S102).

Then, the system control circuit 2 supplies a command to rotate the camera body 81 in the yaw direction toward the initial image pickup direction angle IAO to the image pickup direction control circuit 9 (step S103). As a result, the camera platform 82 of the video camera 8 rotates the image pickup direction of the camera body 81 in the direction indicated by the initial image pickup direction IAO. In this process, the operation of determining whether the rotation of the camera body 81 has been completed is repeatedly executed by the system control circuit 2 till it determines that the rotation has been completed (step S104). If the rotation of the camera body 81 is determined to have been completed in the step S104, the system control circuit 2 fetches by one frame the video signal VD representing the video images outside the vehicle that are picked up by the video camera 8 and overwrites and stores this video signal in the video saving region of the RAM 7, as shown in FIG. 4 (step S105).

Then, the system control circuit 2 performs the A pillar detection processing on the one-frame video signal VD that are stored in the video saving region of the RAM 7 (step S106). Thus, the video signal VD is subjected to an edge processing and shape analysis processing in order to detect the A pillar P_{R} or P_{L} located at the boundary between a front window FW and front door FD of the vehicle, as shown in FIG. 7, from among the images obtained from the video signal VD. This A pillar is one of the pillars supporting the cabin roof of the vehicle.

Then, the system control circuit 2 determines whether the A pillar has been detected from among the images of the one-frame video signal VD by the A pillar detection processing (step S107). If the A pillar is determined to have been undetected in the step S107, the system control circuit 2 adds a predetermined angle K (for example, 10 degrees) to the angle indicated by the left A pillar azimuth POL, as shown in FIG. 4, that has been stored in the RAM 7 and overwrites and stores the resultant angle as a new left A pillar azimuth POL in the RAM 7 (step S108).

Then, the system control circuit 2 supplies a command to rotate the camera body 81 to the left through the predetermined angle K to the image pickup direction control circuit 9 (step S109). As a result, the camera platform 82 of the video camera 8 rotates the image pickup direction of the camera body 81 from the present image pickup direction to the left through the predetermined angle K. After the step S109, the system control circuit 2 returns to the step S104 and repeatedly executes the operations of the steps S104 to S109. Thus, the image pickup direction is repeatedly rotated to the left by the predetermined angle K at a time till the A pillar is detected among the images picked up by the video camera 8, and an angle indicating this final image pickup direction is stored as a left A pillar azimuth POL indicating the direction of the A pillar PL on the passenger seat side, as shown in FIG. 7, in the RAM 7.

If the A pillar is determined in the step S107 to have been detected, the system control circuit 2 issues a command to rotate the camera body 81 in the yaw direction toward the initial image pickup direction angle IAO, in the same manner as in the step S103, to the image pickup direction control circuit 9 (step S110). As a result, the camera platform 82 of the video camera 8 rotates the image pickup direction of the camera body 81 in the direction indicated by the initial image pickup direction angle IAO. In this process, the operation of determining whether the rotation of the camera body 81 has been completed is repeatedly executed by the system control circuit 2 till it determines that the rotation has been completed (step S111). If the step S111 determines that the rotation of the camera body 81 is completed, the system control circuit 2 fetches one frame of the video signal VD representing the image within the vehicle picked up by the video camera 8 and overwrites and stores it in the video saving region of the RAM 7, as shown in FIG. 4 (step S112).

Then, similar to the step S106, the system control circuit 2 performs the A pillar detection processing on the one-frame video signal VD that has been stored in the video saving region of the RAM 7 (step S113).

Then, the system control circuit 2 determines whether the A pillar has been detected from among the images obtained from the one-frame video signal VD by the A pillar detection processing (step S114). If the A pillar is determined to have been undetected in the step S114, the system control circuit 2 subtracts a predetermined angle K (for example, 10 degrees) from the angle indicated by a right A pillar azimuth POR, as shown in FIG. 4, that has been stored in the RAM 7, and overwrites and stores the resultant angle as a new right A pillar azimuth POL in the RAM 7 (step S115).

Then, the system control circuit 2 supplies a command to rotate the camera body 81 to the right through the predetermined angle K to the image pickup direction control circuit 9 (step S116). As a result, the camera platform 82 of the video camera 8 rotates the image pickup direction of the camera body 81 from the present image pickup direction to the right through the predetermined angle K. After the step S116, the system control circuit 2 returns to the step S111 and repeats the operations of the steps S111 to S116. Thus, the image pickup direction is repeatedly rotated to the right by the predetermined angle K at a time till the A pillar is detected among the images picked up by the video camera 8, and an angle indicating this final image pickup direction is stored as a right A pillar azimuth POR indicating the direction of the A pillar P_{R} on the driver seat side, as shown in FIG. 7, in the RAM 7.

If the step S114 determines that the A pillar is detected, the system control circuit 2 adds an angle α that is half the angle of view of the video camera 8 to the right A pillar azimuth POR that has been stored in the RAM 7, as shown in FIG. 4, and stores the result as an outside-vehicle right maximum (limit) image pickup azimuth GOR in the RAM 7 (step S117).

Then, the system control circuit 2 subtracts the angle a that is half the angle of view of the video camera 8 from the left A pillar azimuth POL that has been stored in the RAM 7, as shown in FIG. 7, and stores the result as an outside-vehicle left maximum (limit) image pickup azimuth GOL in the RAM 7 as shown in FIG. 4 (step S118). Thus, as shown in FIG. 7, with the A pillars P_{R} and P_{L} serving as boundaries, the front door FD side becomes an in-vehicle image pickup range, whereas the front window FW side becomes an outside-vehicle image pickup range. The azimuths obtained by shifting toward the outside of the vehicle through the angle α that is half the angle of view of the video camera 8 from the image pickup directions (POR, POL) in which the A pillars (P_{R}, P_{L}) have been detected, so that the A pillars P_{R}, P_{L}are not included in the picked-up image when the images are picked up inside the vehicle, are taken as the final outside-vehicle right maximum image pickup azimuth GOR and outside-vehicle left maximum image pickup azimuth GOL.

After the steps S117 and S118, the system control circuit 2 quits the outside-vehicle image pickup movable range detection subroutine.

By executing the outside-vehicle image pickup movable range detection subroutine, it is possible to detect the outside-vehicle right maximum image pickup azimuth GOR and outside-vehicle left maximum image pickup azimuth GOL that are the limit angles of the image pickup movable range at the time the video camera 8 picks up images outside the vehicle via the front window EW, as shown in FIG. 7. In FIG. 7, the outside-vehicle right maximum image pickup azimuth GOR and outside-vehicle left maximum image pickup azimuth GOL of the outside-vehicle image pickup movable range are shown, by way of an example, with respect to the case in which the video camera 8 is installed in the central position d1.

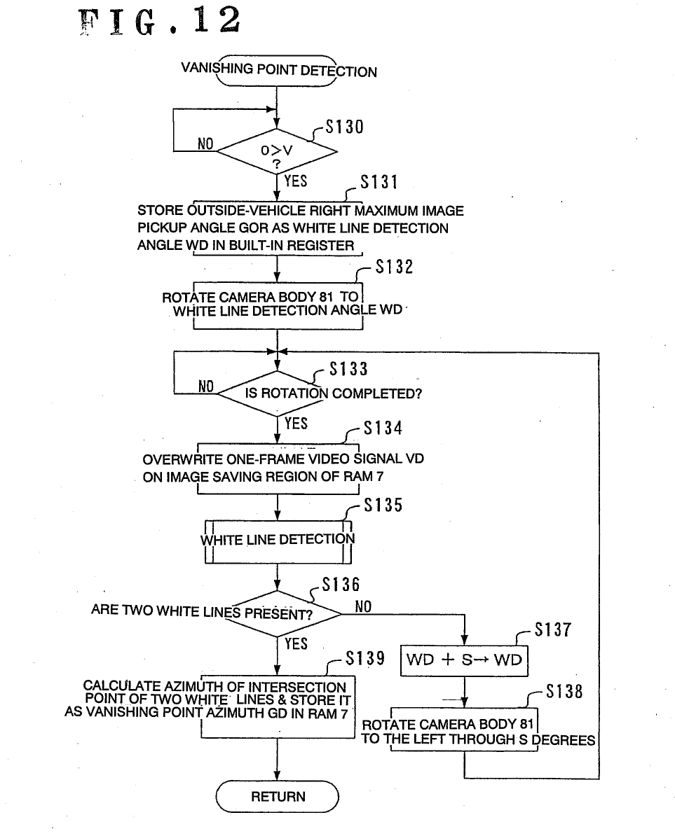

After executing the outside-vehicle photographing range detection subroutine shown in FIG. 10 and FIG. 11, the system control circuit 2 returns to the step S6 shown in FIG. 2. In the step S6, the system control circuit 2 executes a vanishing point detection subroutine shown in FIG. 12.

Referring to FIG. 12, first, the operation of determining whether the vehicle speed indicated by a vehicle speed signal V supplied from the vehicle speed sensor 6 is larger than the speed “0” is repeatedly executed by the system control circuit 2 till it determines that the vehicle speed is larger than zero (step S130). If the vehicle speed indicated by the vehicle speed signal V is determined in the step S130 to be larger than the speed “0” rpm, that is, when the vehicle is determined to be traveling, the system control circuit 2 reads the outside-vehicle right maximum photographing angle GOR that has been stored in the RAM 7 as shown in FIG. 4 and stores this angle as an initial value of a white line detection angle WD in a storage register (not shown in the figure) (step S131).

Then, the system control circuit 2 supplies a command to rotate the camera body 81 in the yaw direction toward the white line detection angle WD that has been stored in the storage register to the photographing direction control circuit 9 (step S132). As a result, the camera platform 82 of the video camera 8 rotates the photographing direction of the camera body 81 in the direction indicated by the white line detection angle WD. In this process, the operation of determining whether the rotation of the camera body 81 has been completed is repeatedly executed by the system control circuit 2 till it determines that the rotation has been completed (step S133). If the rotation of the camera body 81 is determined to have been completed in the step S133, the system control circuit 2 fetches one frame of the video signal VD obtained by photographing images with the camera body 81 and overwrites and stores this frame in the video saving region of the RAM 7 as shown in FIG. 4 (step S134).

Then, the system control circuit 2 executes the white line detection processing to detect a white line or an orange line present on the road, or an edge line of a guard rail provided along the road from the images represented by the one-frame video signal VD (step S135). In the white line detection processing, the system control circuit 2 performs an edge processing and shape analysis processing in order to detect a white line (such as a passing lane line or a travel sector line), an orange line or an edge line of a guard rail formed along the road from the images derived from the video signal VD for each one-frame video signal VD photographed by the camera body 81.

Then, based on the results of the white line detection processing performed in the step S135, the system control circuit 2 determines whether two white lines have been detected (step S136). If the step S136 determines that two white lines are not detected, the system control circuit 2 adds a predetermined angle S (for example, 10 degrees) to the white line detection angel WD that has been stored in the storage register and overwrites and stores the resultant angle as a new white line detection angle WD in the storage register (step S137).

Then, the system control circuit 2 supplies a command to rotate the camera body 81 to the left through the predetermined angle S to the image pickup direction control circuit 9 (step S138). As a result, the camera platform 82 of the video camera 8 rotates the image pickup direction of the camera body 81 from the present image pickup direction to the left through the predetermined angle S.

After the step S138, the system control circuit 2 returns to the step S133 and repeatedly executes the operations of the steps S133 to 138. Thus, the image pickup direction of the video camera is repeatedly rotated to the left by the predetermined angle S at a time till two white lines are detected in the image picked up by the video camera 8. In this process, where two white lines are determined in the step S136 to have been detected, the system control circuit 2 computes an azimuth at which an intersection point of the extension lines obtained by extending the two white lines is present, and stores this azimuth as a vanishing point azimuth GD in the RAM 7 as shown in FIG. 4 (step S139). Thus, the vanishing point azimuth GD that indicates the direction to the vanishing point that serves as a reference when the moving direction of the traveling vehicle on the road is detected is stored in the RAM 7.

After executing the step S139, the system control circuit 2 quits the image pickup initial setting subroutine shown in FIG. 2 and returns to a general control operation under on a main flowchart/program (not shown in the figure) for realizing various functions of the vehicle-mounted information-processing apparatus as shown in FIG. 1.

Here, a software application of picking up a scene inside and outside the traveling vehicle is started. If a outside-vehicle image pickup command is issued by this software application, the system control circuit 2, first, reads the outside-vehicle right maximum image pickup azimuth GOR and outside-vehicle left maximum image pickup azimuth GOL that have been stored in the RAM 7 as shown in FIG. 4. Then, the system control circuit 2 supplies, without any change, the video signals VD supplied from the camera body 81 to the display device 4, while supplying a command to rotate the camera body 81 in the yaw direction within the range between the angles GOR and GOL to the image pickup direction control circuit 9. As a result, the display device 4 displays a scene outside the vehicle that has been picked up by the video camera 8. On the other hand, if the software application issues an in-vehicle image pickup command, the system control circuit 2, first, reads the in-vehicle right maximum image pickup azimuth GIR and in-vehicle left maximum image pickup azimuth GIL that have been stored in the RAM 7 as shown in FIG. 4. Then, the system control circuit 2 generates, based on a video signal VD supplied from the camera body 81, a video signal obtained by a left-right reversal of the image represented by the video signal VD and supplies the generated video signal to the display device 4, while supplying a command to rotate the camera body 81 in the yaw direction within the range between the angles GIR and GIL to the image pickup direction control circuit 9. As a result, the display device 4 displays an image picked up inside the vehicle by the video camera 8 in a form that has been subjected to the left-right reversal. In other words, the image of the in-vehicle scene that is displayed on the display device 4 and the scene inside the vehicle observed by the vehicle occupant are mated by such image reversal.

When an in-vehicle image pickup command is issued by the application software while the images outside the vehicle are being picked up with the video camera 8, the system control circuit 2 may stop the display operation in the display device 4 until the image picking up inside the vehicle becomes ready.

As described above, the vehicle-mounted information-processing apparatus shown in FIG. 1 executes the image pickup initial setting subroutine shown in FIG. 2, so that the azimuth (GF) at which the driver's face is positioned is automatically detected and the image pickup movable range (from GOR to GOL) during outside-vehicle image pickup and image pickup mobile range (from GIR to GIL) during in-vehicle image pickup shown in FIG. 7 are also automatically detected, using the in-vehicle installation position of the video camera 8 as the reference, upon turning on of the power. Further, the vanishing point outside the vehicle is also automatically detected in response to the start of the vehicle movement.

Therefore, if the application software is operated to video-tape the scene inside and outside the traveling vehicle, the direction of driver's face, direction of vanishing point, and image pickup movable ranges inside and outside the vehicle can be determined in advance by using the detection results. As a consequence, the rotation (altering) of the video camera direction during switching the image pickup direction of the video camera 8 from that inside the vehicle (outside the vehicle) to that outside the vehicle (inside the vehicle) can be rapidly implemented. In addition, because each of the above-described detection operations using the installation position of the video camera 8 as a reference is performed each time the power is turned on, a degree of freedom in selecting the instillation position of the video camera 8 inside the vehicle and changing the installation position is increased. Thus, the camera can be installed in any position convenient for the user.

In the in-vehicle image pickup movable range detection subroutine shown in FIG. 8 and FIG. 9, when the A pillar detection is implemented while turning the camera body 81, the initial image pickup direction angle IAI thereof is the image pickup direction angle AG at which the in-vehicle specific point count reaches a maximum (steps S81, S82). However, the initial image pickup direction angle IAI may be decided in a different way.

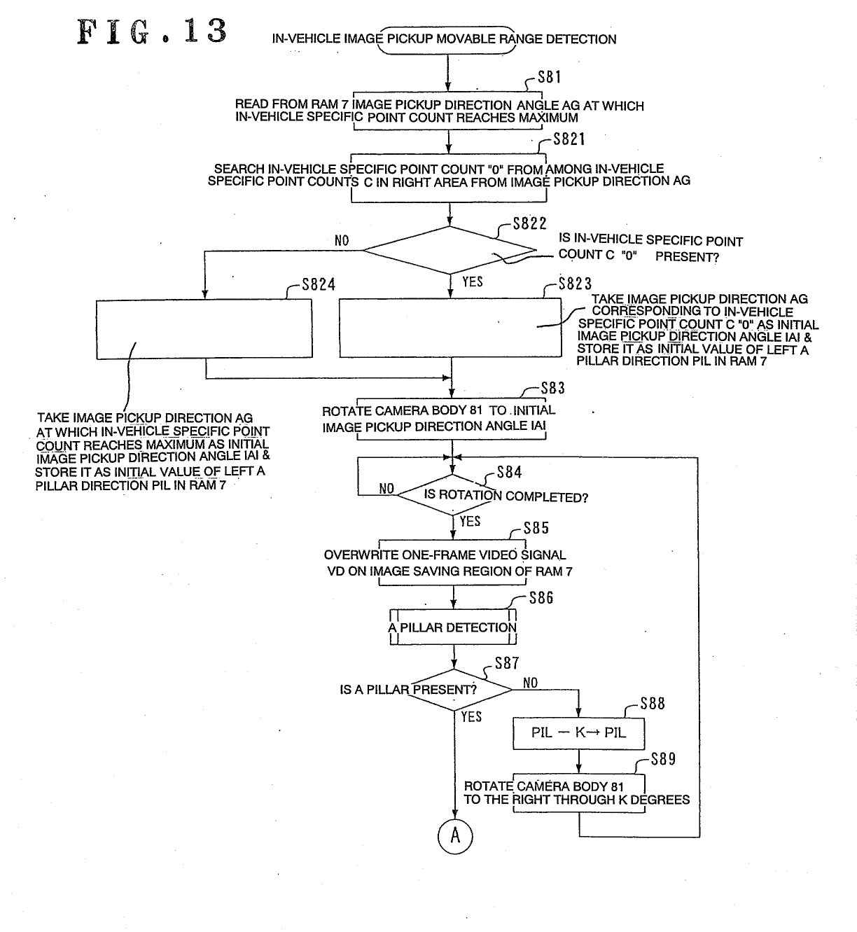

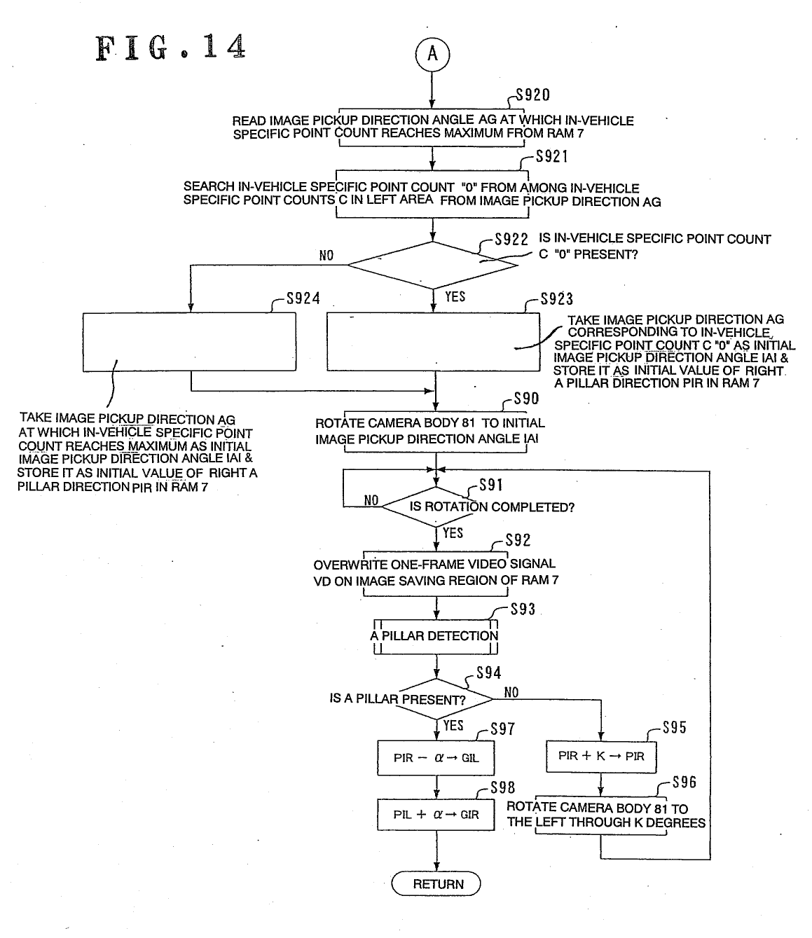

Considering this, FIG. 13 and FIG. 14 illustrate another example of the in-vehicle image pickup movable range detection subroutine.

In the subroutine shown in FIG. 13 and FIG. 14, the steps S821 to S824 are executed instead of the step S82 in the in-vehicle image pickup movable range detection subroutine shown in FIG. 8 and FIG. 9, and the steps S920 to S924 are inserted between the steps S87 and S90.

Therefore, only the operations of the steps S821 to S824 and the steps S920 to S924 will be explained below.

First, in the step S81 shown in FIG. 13, the image pickup direction angle AG corresponding to the maximum in-vehicle specific point count C is read from the RAM 7, and the system control circuit 2 then searches for the specific point count “0” among the in-vehicle specific point counts C corresponding to the angles AG in the right area from this image pickup direction angle AG (step S821). Based on the search results obtained in the step S821, the system control circuit 2 determines whether there is an in-vehicle specific point count C “0” (step S822). If an in-vehicle specific point count C “0” is determined in the step S822 to be present, the system control circuit 2 reads the image pickup direction angle AG corresponding to the in-vehicle specific point count C “0” as the initial image pickup direction angle IAI from the RAM 7 and stores it as the initial value of the left A pillar azimuth PIL in the RAM 7 (step S823). On the other hand, if an in-vehicle specific point count C “0” is determined in the step S822 not to be present, the system control circuit 2 takes the image pickup direction angle AG corresponding to the maximum in-vehicle specific point count C that has been read from the RAM 7 in the step S81 as the initial image pickup direction angle IAI and stores it as the initial value of the left A pillar azimuth PIL in the RAM 7 (step S824).

After the step S823 or S824, the system control circuit 2 advances to the step S83 and executes the steps S83 to S89. In this process, if the step S87 determines that the A pillar is detected, the system control circuit 2 again reads the image pickup direction angle AG corresponding to the maximum in-vehicle specific point count C from the RAM 7, in the same manner as in the step S81 (step S920).

The system control circuit 2 then searches for the specific point count “0” among the in-vehicle specific point counts C corresponding to the angles AG in the left area from this image pickup direction angle AG (step S921).

Based on the search results obtained in the step S921, the system control circuit 2 determines whether there is an in-vehicle specific point count C “0” (step S922). If an in-vehicle specific point count C “0” is determined in the step S922 to be present, the system control circuit 2 reads the image pickup direction angle AG corresponding to the in-vehicle specific point count C “0” as the initial image pickup direction angle IAI from the RAM 7 and stores it as the initial value of the right A pillar azimuth PIR in the RAM 7 (step S923). On the other hand, if an in-vehicle specific point count C “0” is determined in the step S922 not to be present, the system control circuit 2 takes the image pickup direction angle AG corresponding to the maximum in-vehicle specific point count C that has been read from the RAM 7 in the step S920 as the initial image pickup direction angle IAI and stores it as the initial value of the right A pillar azimuth PIR in the RAM 7 (step S924).

After the step S923 or S924, the system control circuit 2 goes to the step S90 to execute the steps S90 to S98.

Thus, in the in-vehicle image pickup movable range detection subroutine shown in FIG. 13 and FIG. 14, when the A pillar detection is performed while rotating the camera, the image pickup direction angle AG corresponding to the in-vehicle specific point count C “0” is used as the initial image pickup direction angle IAI (steps S823, S923). Because the A pillars P_{R} and P_{L} shown in FIG. 7 are not present in the direction in which the in-vehicle specific points, such as the driver sear, passenger seat, rear seat, headrest, or rear window, are present in the picked-up image, the operations of picking up images in this image pickup direction and performing A pillar detection processing can be omitted. For this reason, the direction in which the in-vehicle specific points are absent is taken as the initial image pickup direction. As a result, with such operations, the A pillar detection is performed faster than in the case where the direction in which the A pillar is never present is taken as the initial image pickup direction and then the A pillar detection is successively performed while rotating the camera. In the step S924, the image pickup direction angle AG corresponding to the maximum in-vehicle specific point count C is taken as the initial image pickup direction angle. However, because it is clear that the A pillar is not present in the direction corresponding to the maximum in-vehicle specific point count C, a direction obtained by further rotating the camera from this direction through a predetermined angle (for example, 60 degrees) may be taken as the initial image pickup direction angle.

In the in-vehicle image pickup movable range detection subroutine shown in FIG. 8 and FIG. 9 and also FIG. 13 and FIG. 14, another A pillar P_{R} has to be detected after the A pillar P_{L}, as shown in FIG. 7, has been detected in the steps S84 to S89, and the initial image pickup direction of the video camera 8 is again set to the image pickup direction AG corresponding to the in-vehicle specific point count.

It should be noted that a direction obtained by rotating the video camera 8 from the image pickup direction of the video camera 8 immediately after the detection of A pillar P_{L} has been completed through a predetermined angle (for example, 150 degrees) may be taken as the initial image pickup direction. Alternatively, a direction that is obtained by rotating the video camera 8 after the detection of the A pillar P_{L}, in the direction opposite the rotation direction of the camera to find the A pillar P_{L}, through the rotated angle of the video camera 8 spent till the A pillar P_{L} is detected from the initial image pickup direction may be taken as the initial image pickup direction for detecting another A pillar P_{R}.

If the A pillar is not detected even after rotating the camera body 81 over the accumulated angle of 180 degrees in the in-vehicle image pickup movable range detection subroutine shown in FIGS. 8 and 9 and also FIGS. 13 and 14, the operations of the steps S84 to S89 or S91 to S96 may be repeatedly implemented after reversing the rotating direction of the camera body 81. Thus, in the step S89, the system control circuit 2 rotates the camera body 81 to the left through an angle of K degrees, whereas in the step S96, the system control circuit 2 rotates the camera body 81 to the right through an angle of K degrees.

If neither the A pillar P_{L} nor the A pillar P_{R} is detected or any one of them is not detected in the in-vehicle image pickup movable range detection subroutine, the system control circuit 2 performs an in-vehicle specific point detection processing on the one-frame video signal VD that has been stored in the RAM 7 in the same manner as in the step S12 after the operations of the steps S83 (or S90) to S85 (or S92) have been implemented. Then, the system control circuit 2 stores the two opposite angles of the specific points present in the directions at the largest angular distance on both sides from the initial image pickup direction angle IAI as the in-vehicle right maximum image pickup azimuth GIR and in-vehicle left maximum image pickup azimuth GIL respectively in the RAM 7 as shown in FIG. 4. If the in-vehicle image pickup movable range based on the in-vehicle right maximum image pickup azimuth GIR and in-vehicle left maximum image pickup azimuth GIL is narrower than a predetermined angle (for example, 30 degrees), an angle obtained by adding ±β degrees (for example, 60 degrees) thereto is stored as the final in-vehicle right maximum image pickup azimuth GIR and in-vehicle left maximum image pickup azimuth GIL in the RAM 7 as shown in FIG. 4. If the in-vehicle specific points could be detected only from the initial image pickup direction angle IAI in the in-vehicle specific point detection processing, the direction angles obtained by adding ±90 degrees to the initial image pickup direction angle IAI are taken as the in-vehicle right maximum image pickup azimuth GIR and in-vehicle left maximum image pickup azimuth GIL, respectively.

In the in-vehicle image pickup movable range detection subroutine, the A pillars P_{L} and P_{R} are detected in the steps S86 and S93, respectively. However, if the attachment position of the video camera 8 is in the rear portion inside the vehicle, the detection of the so-called C pillars, that is, left and right rear pillars provided along the rear windows to support the vehicle roof, is performed.

In the outside-vehicle image pickup movable range detection subroutine shown in FIG. 10 and FIG. 11, only the outside-vehicle image pickup movable range at the time the video camera 8 is rotated in the yaw direction is detected. However, the outside-vehicle image pickup movable range in the pitch direction may be additionally detected. For example, between the steps S103 and S104 shown in FIG. 10, first, the system control circuit 2 detects a boundary between the front glass and vehicle ceiling and also detects a vehicle bonnet by the above-described shape analysis processing, while gradually rotating the camera body 81 in the pitch direction. Angles obtained by subtracting an angle equal to half the vertical view angle of the video camera 8 from the two azimuths (of the above-mentioned boundary and bonnet) are stored as the outside-vehicle image pickup movable range in the pitch direction in the RAM 7.

In the vanishing point detection subroutine shown in FIG. 12, the step S130 determines whether the vehicle is moving or not based on the vehicle speed signal V from the vehicle speed sensor 6. However, whether the vehicle is moving or not may be determined based on the vehicle position information supplied from the GPS device 5. Alternatively, the step S130 may detect the motion state of the scene outside the vehicle in order to determine whether the vehicle is moving or not. For example, the system control circuit 2 executes the so-called optical flow processing in which a speed vector for each pixel is computed with respect to the video signal VD obtained by picking up images with the video camera 8 being directed in one predetermined direction within the outside-vehicle image pickup movable range as shown in FIG. 7. The vehicle is determined to be traveling when the speed vector in the outer area of one frame image is larger than that in the central area of the one frame image.

In the vanishing point detection subroutine shown in FIG. 12, the camera body 81 is rotated to the left through S degrees in the step S138 when two white lines are not detected. If one white line is detected, the camera body 81 may be rotated directly in the direction in which the other white line is assumed to be present.

In the vanishing point detection subroutine shown in FIG. 12, the vanishing point is detected by detecting a white line on the road, for example. Alternatively, the aforementioned optical flow processing may be carried out to take a point in which a speed vector in one frame of image reaches a minimum as the vanishing point.

When the vehicle is in a stationary condition, the roll direction correction processing may occasionally be executed to correct the image pickup direction in the roll direction of the video camera 8. Thus, if a stationary state of the vehicle is confirmed, the system control circuit 2 performs a processing to detect edge portions extending in the vertical direction from among the edge portions, for example of telegraph poles and buildings. This processing is applied on the video signal VD obtained by picking up images with the video camera 8 directed in one predetermined direction within the outside-vehicle image pickup movable range. Then, the system control circuit 2 counts the number of edge portions extending in the vertical direction, while gradually rotating the camera body 81 of the video camera 8 in the roll direction. The system control circuit 2 stops the rotation of the camera body 81 in the roll direction when this number reaches a maximum.

The above-described roll direction correction processing automatically corrects the inclination of the video camera even if the video camera 8 is installed with an inclination in the roll direction, or even if the video camera 8 is tilted by vibrations during traveling. In the above-described embodiment, the correction to the attitude of the video camera 8 in the roll direction is performed based on the video signal VD. Alternatively, a so-called G sensor may be provided to detect the inclination so as to perform the correction to the roll direction attitude of the video camera 8 based on the detection signal from the G sensor.

In the image pickup initial setting subroutine shown in FIG. 2, the detection of the in-vehicle image pickup movable range (step S3), driver's face detection (step S4), detection of outside-vehicle image pickup movable range (step S5), and vanishing point detection (step S6) are executed in the order of description, but it is also possible to perform the detection of the outside-vehicle image pickup movable range after detecting the vanishing point and then perform the detection of the in-vehicle image pickup movable range and the detection of driver's face.

It is also possible to detect the installation position of the video camera 8 inside the vehicle by the processing (will be described) and then detect the in-vehicle image pickup movable range by using the processing results, instead of implementing the camera attachment position detection processing as shown in FIG. 5.

First, the system control circuit 2 performs the edge processing and shape analysis processing to detect a driver seat headrest from among the images derived from the video signal VD for each one-frame video signal VD obtained by picking up images with the camera body 81, while gradually rotating the image pickup direction of the camera body 81 in the yaw direction. Once the driver seat headrest is detected, the system control circuit 2 determines whether the image of the driver seat headrest is positioned in the center of one frame image. The image pickup direction of the camera body 81 at the time the driver seat headrest is determined to be positioned in the center is stored as a driver seat headrest azimuth GH in the RAM 7, and the display surface area of the driver seat headrest in the picked-up image is stored as a display surface area MH of the driver seat headrest in the RAM 7. Then, the system control circuit 2 implements the edge processing and shape analysis processing to detect a passenger seat headrest from among the images obtained from the video signal VD. Once the passenger seat headrest is detected, the system control circuit 2 determines whether the image of the passenger seat headrest is positioned in the center of one frame image. The image pickup direction of the camera body 81 at the time the passenger seat headrest is determined to be positioned in the center is stored as a passenger seat headrest azimuth GJ in the RAM 7, and the display surface area of the driver seat headrest in the picked-up image is stored as a display surface area MJ of the passenger seat headrest in the RAM 7. The system control circuit 2 then determines the installation position of the video camera by performing size comparison between the display surface area MJ of the passenger seat headrest and the display surface area MH of the driver seat headrest. When the display surface area MJ of the passenger seat headrest and the display surface area MH of the driver seat headrest are equal to each other, the distance from the video camera 8 to the passenger seat headrest can be considered to be equal to the distance from the video camera 8 to the driver seat headrest. Therefore, in this case, the system control circuit 2 determines that the video camera 8 is installed in the central position dl as shown in FIG. 7. When the display surface area MH of the driver seat headrest is larger than the display surface area MJ of the passenger seat headrest, the system control circuit 2 determines that the video camera 8 is installed in a position closer to the window on the driver seat side correspondingly to the difference between the two surface areas (the larger the difference is, the closer to the window the video camera is). On the other hand, if the display surface area MJ of the passenger seat headrest is larger than the display surface area MH of the driver seat headrest, the system control circuit 2 determines that the video camera 8 is installed in a position closer to the window on the passenger seat side correspondingly to the difference between the two surface areas.

Here, the system control circuit 2 calculates an azimuth intermediate between the driver seat headrest azimuth GH and the passenger seat headrest azimuth GJ as an azimuth θ between the headrests. The system control circuit 2 then adds the between-the-headrest azimuth θ to the driver seat headrest azimuth GH and stores the result as an in-vehicle left maximum image pickup azimuth GIL, as shown in FIG. 7, in the RAM 7, and subtracts the between-the-headrest azimuth θ from the passenger seat headrest azimuth GJ and stores the result as an in-vehicle right maximum image pickup azimuth GIR, as shown in FIG. 7, in the RAM 7.

The present application is based on Japanese Patent Application No. 2005-297536 filed on Oct. 12, 2005, and the entire contents of this Japanese Patent Application are incorporated herein by reference.

1-13. (canceled)

14. A vehicle-mounted image pickup device that picks up a scene inside a vehicle cabin or outside a vehicle, the image pickup device comprising:
a camera;
a camera platform located inside said vehicle for mounting said camera thereon and rotating said camera according to a rotation signal generated in order to change an image pickup direction of said camera;
signal supply means for supplying, to said camera platform, said rotation signal to rotate the image pickup direction of said camera to a yaw direction;
in-vehicle specific point counting means for detecting predetermined in-vehicle specific points, except for A pillars, from an image represented by a video signal obtained by picking up images with said camera, and counting the number of the specific points as an in-vehicle specific point count;
initial direction setting means for determining whether said image pickup direction is set to the inside the vehicle or outside the vehicle based on said in-vehicle specific point count, and setting the direction determined to have been set to the inside the vehicle as an initial direction;
image pickup movable range measurement means for measuring an in-vehicle image pickup movable range of said camera based on said video signal from a state in which said camera faces in said initial direction; and
storage means for storing information indicating said in-vehicle image pickup movable range.

15. The vehicle-mounted image pickup device according to claim 14, wherein said image pickup movable range measurement means starts measurement operation in response to switching on a power source.

16. The vehicle-mounted image pickup device according to claim 14, wherein said image pickup movable range measurement means measures an image pickup movable range of said camera of when said camera picks up an image outside said vehicle, as an outside-vehicle image pickup movable range, after said in-vehicle image pickup movable range is measured.

17. The vehicle-mounted image pickup device according to claim 15, further comprising A pillar detection means for detecting two A pillars of said vehicle based on said video signal, wherein said signal supply means supplies a signal causing said camera to rotate in the yaw direction till said A pillar detection means detects one of said two A pillars from said initial direction,
said image pickup movable range measurement means measures a first A pillar angle indicating an image pickup direction when said A pillar detection means detects one of said two A pillars,
said signal supply means, after one of said two A pillars has been detected, supplies a second signal causing said camera to rotate in the yaw direction till said A pillar detection means detects the other one of said two A pillars from said initial direction;
said image pickup movable range measurement means measures a second A pillar angle indicating an image pickup direction when said A pillar detection means detects said other one of said two A pillars; and
said image pickup movable range measurement means measures said in-vehicle image pickup movable range based on said first A pillar angle and second A pillar angle.

18. The vehicle-mounted image pickup device according to claim 17, wherein said image pickup movable range measurement means comprises means for obtaining a maximum image pickup azimuth in said in-vehicle image pickup movable range by adding a predetermined angle to said first A pillar angle, and obtaining another maximum image pickup azimuth in said in-vehicle image pickup movable range by subtracting said predetermined angle from the second A pillar angle.

19. The vehicle-mounted image pickup device according to claim 18, wherein each of said predetermined angle and said second predetermined angle is half an angle of view of said camera.

20. The vehicle-mounted image pickup device according to claim 14, further comprising means for supplying said video signal without modification to a display device when the image pickup direction of said camera is set to an outside-vehicle direction and supplying said video signal that has undergone left-right reversal of an image based on said video signal to said display device when the image pickup direction of said camera is set to an in-vehicle direction.

21. An image pickup movable range measurement method for a vehicle-mounted camera to measure an image pickup movable range of a camera installed inside a vehicle cabin, the method comprising:
a step of detecting predetermined in-vehicle specific points, except for A pillars, from an image represented by a video signal obtained by picking up images with said camera, and counting the number of the specific points as an in-vehicle specific point count;
a step of determining whether said image pickup direction is set to the inside the vehicle or outside the vehicle based on said in-vehicle specific point count, and setting the direction determined to have been set to the inside the vehicle as an initial direction; and
an in-vehicle image pickup movable range measurement step of detecting two A pillars of said vehicle from an image represented by said video signal based on the video signal obtained by picking up images with said camera, while rotating the image pickup direction of said camera from said initial direction to a yaw direction, and determining the in-vehicle image pickup movable range based on the image pickup directions of said camera when said two A pillars are detected.

22. The image pickup movable range measurement method for a vehicle-mounted camera according to claim 28, wherein said in-vehicle image pickup movable range measurement step comprises: obtaining a maximum image pickup azimuth in said in-vehicle image pickup movable range by adding a predetermined angle to said first A pillar angle; and obtaining another maximum image pickup azimuth in said in-vehicle image pickup movable range by subtracting said predetermined angle from the second A pillar angle.

23. The image pickup movable range measurement method for a vehicle-mounted camera according to claim 22, wherein each of said predetermined angle and said second predetermined angle is half an angle of view of said camera.

24. The image pickup movable range measurement method for a vehicle-mounted camera according to claim 21, further comprising a step of supplying said video signal without modification to a display device when the image pickup direction of said camera is set to an outside-vehicle direction, and supplying said video signal that has undergone left-right reversal of an image based on said video signal to said display device when the image pickup direction of said camera is set to an in-vehicle direction.

25. The vehicle-mounted image pickup device according to claim 14, wherein said in-vehicle specific point counting means counts said in-vehicle specific points in a plurality of directions, and said initial direction setting means sets a direction in which said in-vehicle specific point count reaches a maximum as said initial direction.

26. The vehicle-mounted image pickup device according to claim 17, wherein said A pillar detection means does not perform A pillar detection during a period when said camera is rotated from said initial direction to a prescribed angle in the yaw direction.

27. The vehicle-mounted image pickup device according to claim 26, wherein said prescribed angle is an angle at which said specific point count is zero.

28. The image pickup movable range measurement method for a vehicle-mounted camera according to claim 21, wherein said in-vehicle image pickup movable range measurement step comprises:
a first A pillar detection step of detecting a rotation angle of said camera from said initial direction in the yaw direction till one of said two A pillars is detected;
a step of returning said camera to said initial direction after said one A pillar has been detected;
a second A pillar detection step of detecting a rotation angle of said camera from said initial direction in a direction opposite said yaw direction till the other one of said two A pillars is detected; and
a step of measuring said in-vehicle image pickup movable range based on said first A pillar angle and said second A pillar angle.

29. The image pickup movable range measurement method for a vehicle-mounted camera according to claim 21, wherein the step of obtaining said in-vehicle specific point count is performed a plurality of time to obtain said in-vehicle specific point counts in a plurality of direction, and the step of setting said initial direction sets a direction in which said in-vehicle specific point count reaches a maximum as said initial direction.

30. The image pickup movable range measurement method for a vehicle-mounted camera according to claim 21, wherein said in-vehicle image pickup movable range measurement step does not perform the A pillar detection during a period when said camera is rotated from said initial direction to a prescribed angle in the yaw direction.

31. The image pickup movable range measurement method for a vehicle-mounted camera according to claim 30, wherein said prescribed angle is an angle in which said specific point count is zero.

32. The vehicle-mounted image pickup device according to claim 14, wherein said predetermined in-vehicle specific points include at least one of a part of a driver's seat, a part of a passenger's seat, a part of a rear seat, a part of headrests and a part of a rear window.

33. The image pickup movable range measurement method for a vehicle-mounted camera according to claim 21, wherein said predetermined in-vehicle specific points include at least one of a part of a driver's seat, a part of a passenger's seat, a part of a rear seat, a part of headrests and a part of a rear window.
